(19) United States
(12) Patent Application Publication
(10) Pub. No.: US 2023/0103479 A1
(43) Pub. Date: Apr. 6, 2023

(54) ASYNCHRONOUS VIDEO/AUDIO ROLEPLAY AND REVIEW SYSTEM AND METHOD

(71) Applicant: FORT ST. APPS, Oak Park, IL (US)

(72) Inventors: Brendan GILLIGAN, Oak Park, IL (US); Andres LARES, Oak Park, IL (US)

(73) Assignee: FORT ST. APPS, Oak Park, IL (US)

(21) Appl. No.: 17/491,043

(22) Filed: Sep. 30, 2021

(51) Int. Cl. G09B 5/06; G06N 20/00; H04N 21/442; H04N 21/44; H04N 21/439

(52) U.S. Cl. CPC G09B 5/065; G06N 20/00; H04N 21/4394; H04N 21/44008; H04N 21/44218

(57) ABSTRACT

An asynchronous system and method which facilitates automatic real-feel video roleplay and simulates real situations. The system and method include displaying a video to a user and recording the user’s reactions and responses to the video. Further, system is configured to display a video of a person or an animated character listening and/or nodding their head while recording the user’s reactions and responses to give a real-feel. Additionally, the system and method analyze user’s responses and displays a next video based on the user’s response.

### BACKGROUND OF THE INVENTION

The present disclosure relates to a system and method for training, review and evaluation of a user using video and audio technologies.

With the rapid development of computers and Internet of Things (IoT) technology, training and review of a user using multimedia audio and video have become more popular under various environments. Corporations, non-profit organizations, colleges, schools, and other institutions are using video and audio devices and methods for teaching, training, interviewing, and roleplay.

The current solutions usually include a camera to record video and a video display device to display video. The user watches the video. At the end of the video, the user has to manually click on buttons/give inputs to go to the next scenario/scene/video. Further, existing systems do not provide a realistic experience, which may be referred to as a real-feel effect hereafter, to the user, but instead provide a pre-recorded feel to the user. Additionally, the current systems do not provide the user with various options for grading/reviewing or evaluating different tasks/efforts, such as self-grading, peer review, mentor review, etc. Furthermore, in the current systems typically, the user must physically click buttons or provide inputs, so as to navigate through the entire teaching, training, and role-playing processes.

### SUMMARY OF THE INVENTION

In light of the above-mentioned shortcomings associated with teaching, training and video roleplay systems, it is highly desirable to have a system/method which automatically helps a user to navigate through the system/method based on the user’s responses and also provides a realistic experience to the user while the user is being taught, trained and/or performing role-playing. In such instances, the training and/or role-playing can be performed in an asynchronous manner, with the trainer recording video or audio in advance, while the user receives the feeling that the training/role-playing is occurring synchronously.

The roleplaying completed by users according to aspects of the invention is done around scenarios that are created in advance, by an administrator, and provided to users. Prior to roleplaying and/or responding in any way, users review scenario information, describing all of the necessary details for them to roleplay and/or respond. This information can be provided via text, video, audio, or other documents. When users are utilizing this system to roleplay, this is referred to as a simulation or situation. Situations can be created around any topic, a few such examples are sales, procurement, marketing, difficult conversations, hiring or firing employees, or management or leadership discussion. Each of these situations is made up of various stages. Each stage is made up of prompt video/audio, transition video/audio, response/input video/audio, and a grading system. The creation of the situation, and all the necessary details around the stages, grading, and pre-determined rules are all completed by the administrator. Administrators may also allow third-party evaluators to have the ability to create situations, stages, create or adjust rules, and create or adjust grading.

Embodiments of the present disclosure present technological improvements as solutions to one or more of the above-mentioned technical problems recognized by the inventor in conventional systems.

Aspects of the present invention disclose a system and method for facilitating automatic video roleplay. A system and method for automatic video roleplay is described, which is comprised of a hardware processor communicably coupled via a communication network with at least one display device, at least one input device, and at least one memory device, to provide a real and automatic feel to a user using the training/role-playing system and method. This is done by showing a prompt video to the user which the user must then respond to; however, while the user is responding, the user is viewing a transition video. The transition video is displayed after the prompt video, wherein the transition video is a video of the person(s) or animated character(s) present in the prompt video listening through physical gestures, nodding their head, and/or making sounds, such as “uh-huh” or “yes” to give the user the sense that the user is being listened to, giving the user a realistic experience. The same can occur with audio only, whereby the system can instead simply provide transition audio after providing prompt audio with the trainer or instructor. Hereinafter, the term prompt video/audio may be used to indicate either video or audio, and transition video/audio to indicate either video or audio. Also, the term input or video/audio may be used to indicate either video or audio.

Additionally, in an aspect of the present invention, the system and method have integrated artificial intelligence (Al) and Machine Learning (ML) to detect completion of the user’s responses, automatically proceed to the next step/video, and determine which prompt video would be most relevant based on the user’s response.

One of the embodiments of the present disclosure provides a system for automatic video roleplay, the system comprising a hardware processor configured to display a prompt video on a display device; display a transition video on the display device upon the completion of the first video; receive an input video from an input device from a user while displaying the transition video; and analyze the input videos to identify the input from the user and a rule corresponding to the input from a rule set; display a response video on the a display device based on the identified rule corresponding to the input from the user upon completion of the transition video; and a memory device communicably coupled to the processor, wherein the memory device is operable to store the prompt video, the rule set, the transition video, the user input video and the response video.

In another aspect, the same disclosure teaches a method of automatic video roleplay, the method to be processed using a hardware processor, the method comprising: displaying a prompt video on a display device; displaying a transition video on the display device upon the completion of the prompt video; receiving an input video from an input device from a user while displaying the transition video; analyzing the input video to identify an input from the user and a rule corresponding to the input from a rule set stored in a memory device communicably coupled to the hardware processor; displaying a response video stored in the memory device on the display device based on the identified rule corresponding to the input upon completion of the transition video.

Beneficially, aspects of the present invention provide a system and method of asynchronous video roleplay based training and evaluation which is smooth and automatic, providing a realistic experience, unlike the present existing asynchronous systems and solves technical problems associated with the same. In order for this realistic experience to occur, whether stored locally or in the cloud, the prompt and transition videos are loaded to the user’s hardware prior to beginning the roleplay to ensure smooth transitions between videos. It is also important to note that the transition video mimics the current standard of video conferencing, specifically whereby the transition video is much more prominent for the user, while recording a response, than the recording of the user’s input video.

The transition video being more prominent mimics a typical synchronous videoconference (“Zoom”) like communications. Other platforms do not work in a similar manner.

As noted, the transition video mimics a human listening to the user speaking. It is currently designed in a manner familiar with users of common video conferencing applications. The solution is a much more natural environment for the user to communicate with.

According to another aspect, a method allows for bi-directional or full duplex communication with the system allows for the user to achieve a real feel. This also allows the system to collect data on how the student listens and reacts for the entire conversation and not just during a response portion as is the case in methods only comprised of recording the user’s response.

Additional aspects, advantages, features and objects of the present disclosure would be made apparent from the drawings and the detailed description of the illustrative embodiments construed in conjunction with the appended claims that follow.

It will be appreciated that features of the present disclosure are susceptible to being combined in various combinations without departing from the scope of the present disclosure as defined by the appended claims.

While the systems and methods are illustrated by use of smart phone mobile device embodiments and applications, they are equally applicable to virtually any personal computer or portable or mobile communication device, including for example, a desktop computer, laptop computers, tablet, and virtual reality headset.

### BRIEF DESCRIPTION OF THE DRAWINGS

The summary above, as well as the following detailed description of illustrative embodiments are better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those in the art will understand that the drawings are not to scale. Wherever possible, like elements have been indicated by identical numbers.

Embodiments of the present disclosure will now be described, by way of example only, with reference to the following diagrams wherein:

FIG. 1 is a schematic illustration of a system for automatic video roleplay, in accordance with an embodiment of the present disclosure.

FIG. 2 is an illustration of operations for automatic video roleplay, in accordance with an embodiment of the present disclosure.

FIG. 3 is a screenshot of a login screen for a user to a coaching system and method in accordance with an embodiment of the present disclosure.

FIG. 4 is a screenshot of a coach home dashboard for the coaching system and method in accordance with an embodiment of the present disclosure.

FIG. 5 is a screenshot of a situations page to create situations for a group and view all the situations previously created for the coaching system and method in accordance with an embodiment of the present disclosure.

FIG. 6 is a screenshot of a create situations page to create a situation including situation information for the coaching system and method in accordance with an embodiment of the present disclosure.

FIG. 7 is a screenshot of a creating stages and stage edit page to enable a coach to decide who will perform grading for the coaching system and method in accordance with an embodiment of the present disclosure.

FIG. 8 is a screenshot of a coach grading and feedback page where grading occurs for the coaching system and method in accordance with an embodiment of the present disclosure.

FIG. 9 is a screenshot of a simulation experience page with an example of a real-feel effect for the coaching system and method in accordance with an embodiment of the present disclosure.

FIG. 10 is a screenshot of a student grading page for a student to perform grading of themselves or a peer for the coaching system and method in accordance with an embodiment of the present disclosure.

FIG. 11 is a flowchart for a smart-response system and method in accordance with an embodiment of the present disclosure.

### DETAILED DESCRIPTION OF THE EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practicing the present disclosure are also possible.

Aspects of the present invention disclose a system and method for facilitating automatic and real-feel video roleplay based training and evaluation. The system enables a user to see a prompt video on a graphical user interface which is provided on a display device, respond to the prompt video depending on what the prompt video requires or requests the user to do, wherein the response (including listening) is captured by an input device. Additionally, while the user is responding to the prompt video, a transition video is displayed on the graphical user interface, wherein the transition video is a video of a person present in the prompt video, listening and/or reacting to the user’s responses, to give a feeling to the user as if the person is listening to the user even though the person is not contemporaneously present (the process being performed asynchronously).

In an embodiment of the present invention, the system and method enable a hardware processor to analyze the user’s response and display the most relevant next prompt (response) video on the display device, based on the user’s response. This provides an automatic system and method, wherein the training/coaching takes a path as per the user’s responses.

In an embodiment of the present invention, the system and method use artificial intelligence (AI) and machine learning (ML), which enable a hardware processor to identify when the user has completed the response to the prompt video and automatically end the transition video and displays a second prompt video, as the next step. Thereby, the system and method, when looked upon as a whole, provides the user with a real-feel, automatic video roleplay, which can be used for training, coaching and evaluation. The identification of when the user has completed the response, for automatic advancement, is based upon a pre-determined period of time where the user is not responding. Exceeding that time period, where noise may occur, but the user is not responding by speaking in a manner consistent with previous portions of the response, will indicate to the system that the user is finished and proceed to the next prompt video.

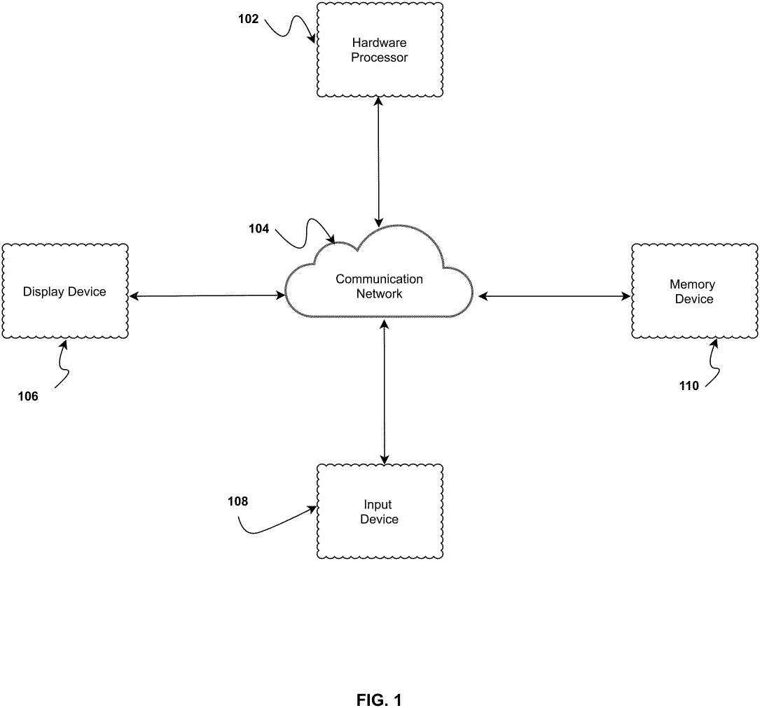

FIG. 1 is a schematic illustration of an exemplary embodiment of the automatic asynchronous video roleplay system 100, wherein the automatic video roleplay system 100 comprises a hardware processor 102 communicably coupled via a communication network 104 with a display device 106, an input device 108, and a memory device 110. Of course, there may be multiple hardware processors 102, communication networks 104, display devices 106, input devices 108 and memory devices 110 as part of the automatic video roleplay system.

Any part of the communication network 104 can be wireless, such as through cellular or wi-fi connectivity or blue-tooth, or through a wired connection. The hardware processor 102 is configured to display a prompt video on the device 106 and display a transition video on the display device 106 upon the completion of the prompt video. Further, the hardware processor 102 is configured to receive an input video from the input device 108 from a user while displaying the transition video. Furthermore, the hardware processor 102 is configured to analyze the input video to identify a) an input from the user and b) a rule (or rules) corresponding to the input from, in which the rule is part of a rule set stored in the memory device 110. The input is provided in the form of an input video recorded by the user in real-time. Moreover, the hardware processor 102 is further configured to display a response video on the display device 106 based on the identified rule corresponding to input video, upon completion of the transition video. It is contemplated that there can be multiple prompt videos, transition videos, input videos, rules and rule sets, and response videos, but the disclosure provides an explanation assuming these are singular for simplicity’s sake. Here, the hardware processor 102 is able to determine a response from the video through interpretation of audio that is present in the input video.

In an embodiment of the present invention, a first audio, a transition audio, an input audio and a response audio may be providing by the trainer/coach and the user instead of video.

Further, it is contemplated that the response, instead of video or audio, may be a touch or a click on a touch pad of the display device 106.

In an embodiment of the present invention, the memory device 110 is communicably coupled to the hardware processor 102 through the communication network 104, wherein the memory device 110 is operable to store the prompt video, the rule set, the transition video, the user input video, and the response video. Once again, any of the videos and the rule set can be plural in number, and any of the videos can be audio instead.

One or more components of the invention are described as a unit for the understanding of the specification. For example, a unit may include a self-contained component in a hardware circuit comprising of logical gate, semiconductor device, integrated circuits or any other discrete component. The unit may also be a part of any non-transitory software program executed by any hardware entity, for example, a processor. The implementation of a unit as a software program may include a set of logical instructions to be executed by the hardware processor 102 or any other hardware entity.

Additional or less units can be included without deviating from the novel art of this disclosure. In addition, each unit can include any number and combination of sub-units, and systems, implemented with any combination of hardware and/or software units.

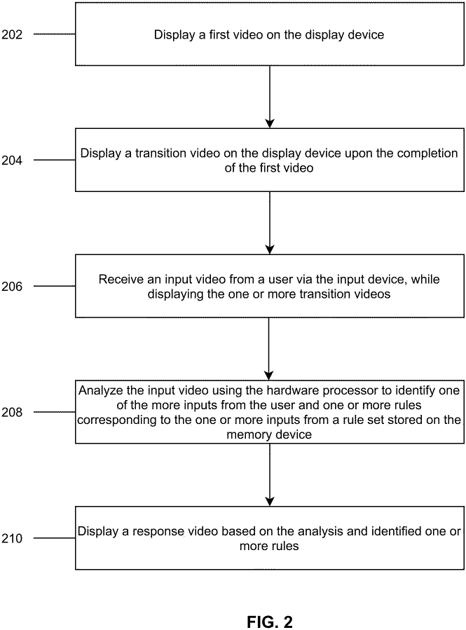

FIG. 2 shows operations of the system 100 which are performed by the hardware processor 102 or a combination or one or more hardware processors executing a program tangibly (non-transitorily) embodied on a computer-readable medium to perform functions of the invention by operating on inputs and generating outputs. Suitable processors include, by way of example, both general and special purpose microprocessors. Generally, the hardware processor 102 receives (reads) instructions and data from the memory device 110 (such as a read-only memory (ROM) and/or a random-access memory) and writes (stores) instructions and data to the memory device 110. Storage devices suitable for tangibly embodying computer program instructions and data include, for example, all forms of non-volatile memory, such as semiconductor memory devices, including EPROM, EEPROM, and flash memory devices; magnetic disks such as internal hard disks and removable disks; magneto-optical disks; and CD-ROMs. Any of the foregoing may be supplemented by, or incorporated in, specially-designed ASICs (application-specific integrated circuits) or FPGAs (Field-Programmable Gate Arrays). A computer can generally also receive (read) programs and data from, and write (store) programs and data to, a non-transitory computer-readable storage medium such as an internal disk (not shown) or a removable disk.

The communication network 104 may include the Internet or any other network capable of communicating data between devices. Suitable networks may include or interface with any one or more of, for instance, a local intranet, a PAN (Personal Area Network), a LAN (Local Area Network), a WAN (Wide Area Network), a MAN (Metropolitan Area Network), a virtual private network (VPN), a storage area network (SAN), a frame relay connection, an Advanced Intelligent Network (AIN) connection, a synchronous optical network (SONET) connection, a digital T1, T3, E1 or E3 line, Digital Data Service (DDS) connection, DSL (Digital Subscriber Line) connection, an Ethernet connection, an ISDN (Integrated Services Digital Network) line, a dial-up port such as a V.90, V.34 or V.34bis analog modem connection, a cable modem, an ATM (Asynchronous Transfer Mode) connection, or an FDDI (Fiber Distributed Data Interface) or CDDI (Copper Distributed Data Interface) connection. Furthermore, communications may also include links to any of a variety of wireless networks, including WAP (Wireless Application Protocol), GPRS (General Packet Radio Service), GSM (Global System for Mobile Communication), CDMA (Code Division Multiple Access) or TDMA (Time Division Multiple Access), cellular phone networks, GPS (Global Positioning System), CDPD (cellular digital packet data), RIM (Research in Motion, Limited) duplex paging network, Bluetooth radio, or an IEEE 802.11-based radio frequency network. The communication network 104 can further include or interface with any one or more of an RS-232 serial connection, an IEEE-1394 (Firewire) connection, a Fiber Channel connection, an IrDA (infrared) port, a SCSI (Small Computer Systems Interface) connection, a Universal Serial Bus (USB) connection or other wired or wireless, digital or analog interface or connection, mesh or Digi® networking. The communication network 104 may include any suitable number and type of devices (e.g., routers and switches) for forwarding commands, content, and/or web object requests from each client to the online community application and responses back to the clients.

Throughout the disclosure, the display device 106 refers to any and all types of display devices including, but not limited to, a graphical user interface (GUI), a display screen, a projector, a television screen, or a monitor, or a combination thereof.

In an embodiment of the present disclosure, the prompt video has a person speaking or providing instructions. The prompt video may require or request the user to provide a response as an input. The response of the user is captured as an input video by the input device 108 which has a camera/microphone.

Throughout this disclosure the term “input device” refers to a device such as, but not limited to, a video camera, any device capable of capturing video along with audio, any device capable of capturing just audio, a mobile phone, tablet, a laptop, any device with a touch pad, or a personal computer with a web camera connected to a widely accessible network such as the Internet. In the following description, the input device 108 refers to any of the devices capable of capturing video and/or audio.

The input device 108 may be compatible with one or more of the following network standards: GSM, CDMA, LTE, IMS, Universal Mobile Telecommunication System (UMTS), RFID, 4G, 5G, 6G and higher. Further, the input device 108 may communicate with a global positioning satellite (GPS) satellite via the communication network 104. The input device 108 may communicate with mobile network operators using a mobile base station. The user may respond to first video by providing inputs via the input device 108. The input may be received by the user device via one or more of touch, audio, video, click, selection.

In another aspect of the present invention, the hardware processor 102 is further configured to analyze the input video to identify an input from the user and what the input signifies. This is done by transcribing to text the audio portion of the response/input video from the user and then comparing it to a predetermined criterion. Based on this comparison to the pre-determined criterion, the system will then decide which response (possibly a next prompt) video to present to the user. The hardware processor 102 identifies one or more rules corresponding to the analyzed input, wherein the rule is from a rule set, the rule defining a next action or step to be performed. Based on the identification and the rule the hardware processor 102 is configured to display a response video on the display device 106 upon completion of the transition video.

To provide a specific example of this embodiment: a user takes part in a sales training roleplay. The user reviews scenario/simulation information to prepare. The prompt video is one of a person asking the user to respond to “How much would all of these services cost?” The user, while viewing a transition video, must then provide an input. If the user says a number less than $100,000, then the response video will be video A, a response video with a person/animated character saying, “Wow, that’s cheaper than I thought... I mean, ok, let me think about it more.” If the user’s input contains a number between $100,001 and $200,000, then video B is the next prompt video shown to the user. An example of video b might be a response video, “I’m not sure if we can make that work. Can you tell me more about your pricing structure?” And, if the user’s input contains a number that is $200,000 or more, then video C will be the response video shown to the user. An example of video C might be, “Wow, that’s a lot more expensive than I thought. Why is it so expensive?” This decision making by the system is done by transcribing the user’s input via speech to text, comparing the converted text to a set of pre-written rules from the rule set, and then outputting the appropriate response video. Because it is impossible to pre-emptively consider every possible input by the user, should the input video not be recognized or the system not be able to properly compare the input to the rule set, then the rule set will define a default response video for these cases. In the example above, this could be video B, for example, a central/middle video, or a fourth video, video D, that asks for more clarification from the user. The above comparison to a set of pre-written rules is not limited to numbers, it may also occur with pre-determined words, names, or phrases. This aspect of the system will hereby be referred to as smart-response.

Alternatively, in another embodiment, the hardware processor 102 is configured to detect the completion of the user’s input when there is a long delay without speech input from the user, which is done through a pre-determined rule set, and/or the meaning of the user’s input being such that it is obvious to the system that the user has completed a response input. As an example of each of the two methods, should the user respond to the example above with, “The cost is $125,000”, the first method might move on to the response video after 3 seconds without additional speaking from the user, and the second method will interpret the finality of the sentence, combined with no additional speaking for 3 seconds as completion of the input. This detection of completion of the user’s input will in turn stop the display of the transition video and display the next response video on the display device 106. Optionally, the transition video is displayed on the display device 106 until the user indicates the completion of the input. This can be done through physical inputs such as clicking on a button in the system, tapping the screen where touchscreens are available, hitting any key on a keyboard, or clicking a button on a virtual reality headset controlled.

According to an aspect of the present invention, the user is displayed live on the display device 106 after the prompt video, along with the transition video. This is done by showing the user, live recording the input video, on a small sub-window portion of the display device 106. This allows the user to see themselves to provide both a more comfortable roleplaying experience and a more realistic experience, mimicking the current standards in video conferencing. This can be done in a coaching and grading system environment to be described.

FIG. 2 depicts an embodiment of a method for automatic video roleplay, wherein the various units above are explained in operation. The method comprises method steps being executed by the hardware processor 102 communicably coupled via the communication network 104 with the display device 106, the input device 108 and the memory device 110, being executed by a non-transitory computer readable medium including program code stored in the memory device 110. Upon execution by the hardware processor 102, the program code executes in an environment of computer systems providing the method for automatic video roleplay. At step 202, a prompt video is displayed on the display device 106. At step 204, a transition video is displayed on the display device 106 upon the completion of the prompt video. At step 206, an input video or some type of input is received from a user via the input device 108, while displaying the one transition video. The transition video automatically plays until the user is done their response. It will keep looping if the response video is longer than the transition video.

At step 208, the hardware processor 102 analyzes the input video to identify the input from the user and a rule or rules corresponding to the input, wherein the rule is determined from a rule set stored the memory device 110. At step 210, a response video is displayed based on the analysis and identified rule.

According to an aspect of the present invention, the hardware processor 102 is configured to facilitate the grading of the user based on the prompt video, the user input video, and a grading rule from the rule set, wherein the grading of the user is done by the user, thereby providing a system for self-evaluation. In this embodiment, the hardware processor 102 is configured to display one or more evaluation criteria to the user. Criteria that the user would use to grade could include aspects such as body language, the way a message is communicated, the content of the video, confidence in the communication, and inclusion of specific phrases or concepts in a response. In an alternate embodiment, the hardware processor 102 is configured to facilitate the grading of the one or more users based on the prompt video, the user input video, and one or more grading rules from the rule set, wherein the grading of the user is done by an evaluator separate and distinct from the user. These separate evaluators could take the form of a peer of the user (known as peer-to-peer review), thereby providing a system for peer review. This is done by assigning each input to a peer within the same group. For example, four users take part in a roleplay using this system. User 1 is assigned to grade user 2, user 2 is assigned to grade user 3, user 3 is assigned to grade user 4, and user 4 is assigned to grade user 1. The assignment of the grading to a peer only occurs once the user and the peer assigned to grade the input have both completed the input in order to ensure that neither party is in an advantageous position. Alternatively, optionally, the evaluator may be a third party, including a manager, a coach, a mentor, an external expert, a supervisor or a guide of the user, who is given the task of evaluation. The assignment of self, peer-to-peer, or third-party evaluator is selected when the roleplaying scenario is originally created. At that time, the creator of the roleplay — the administrator that creates the situation or a third-party evaluator assigned the rights by the administrator to create a situation — may choose to select the specific third-party evaluator or allow any third-party evaluator to grade the user’s input. Third-party evaluators may also provide grading for any peer-to-peer assigned grading, allowing them to step in to avoid delays, since peer-to-peer grading requires both parties to submit their inputs prior to the grading being available for either party. It is relevant to note that the user may not be aware of the evaluation type prior to completing the roleplay to attempt to ensure that the user takes the roleplay seriously.

For example, in one embodiment, the user is not aware, prior to submitting his/her input video , whether the input video will be graded by the same user (self-evaluation, according to grading criteria and/or grading guidance that is provided after completion of the responses), a peer, through peer-to-peer coaching, or a third party evaluator such as a coach/mentor.

In an alternative embodiment of the same invention, the system 100 is built using a distributed ledger based platform as an alternative to memory device 110. In this embodiment, the distributed ledger based platform is operable to store the prompt video, the rule set, the transition video, the user input video, and the response video, and also facilitates the hardware processor 102 to perform the method steps shown in FIG. 2.

The following provides various embodiments and examples of aspects of the present disclosure in a more visual manner, but other embodiments that fall within the confines of the present invention are contemplated as well.

### Coach Walk-Through

The following shows an example of an evaluation system and method where there is a coach enabled user.

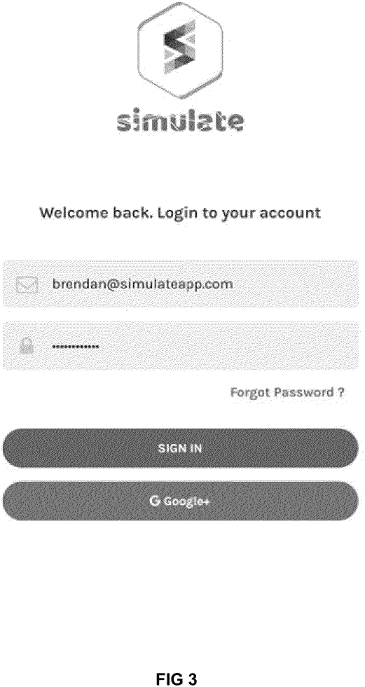

FIG. 3 shows a login screen for a user. Each user has a login so that the information is secure and so that each user can be assigned a role to play and a group. This arrangement manages what scenarios each user has access to along with grading access, etc.

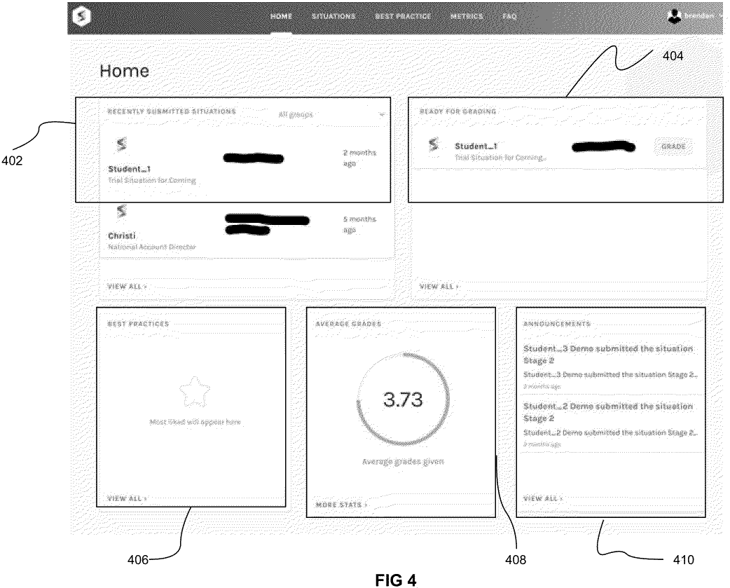

FIG. 4 shows a third-party’s, in this case a Coach’s, home dashboard. The coach can view any tasks such as any grading assignments needed.

This screen shows the home screen for a third-party evaluator (coach/manager/expert). The top left box 402 show situations that were recently submitted, the top right box 404 shows the inputs that are ready for grading by the coach, the bottom left box 406 is the best practices showing whatever this specific coach would have labelled as well done, the bottom middle box 408 shows the average grade given, and finally, the bottom right box 410 shows the announcements where an administrator can disseminate any important information such as timelines, additional scenarios that are released, reminder to grade, etc.

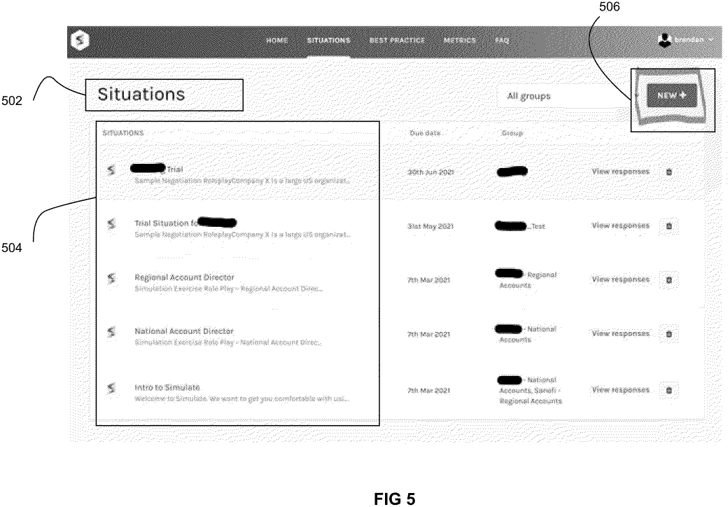

FIG. 5 shows a Situations Page where the coach - given this privilege by the administrator, can create new situations for a group and view all the situations they have been previously created.

The administrator decides who has access to specific situations and who will be assigned to grade each stage. For third party evaluators such as coaches, managers, experts, they can see all of the situations 502 in the box 504 that they can grade or have graded. For participants (users), they see all the situations they have to respond to, have responded to, or can/should grade. This is the case for both self-evaluation and peer-to-peer grading, when enabled. Coaches can create simulations so at the top right corner, there is a NEW button 506, but that would not be available to regular users who do not have this capacity.

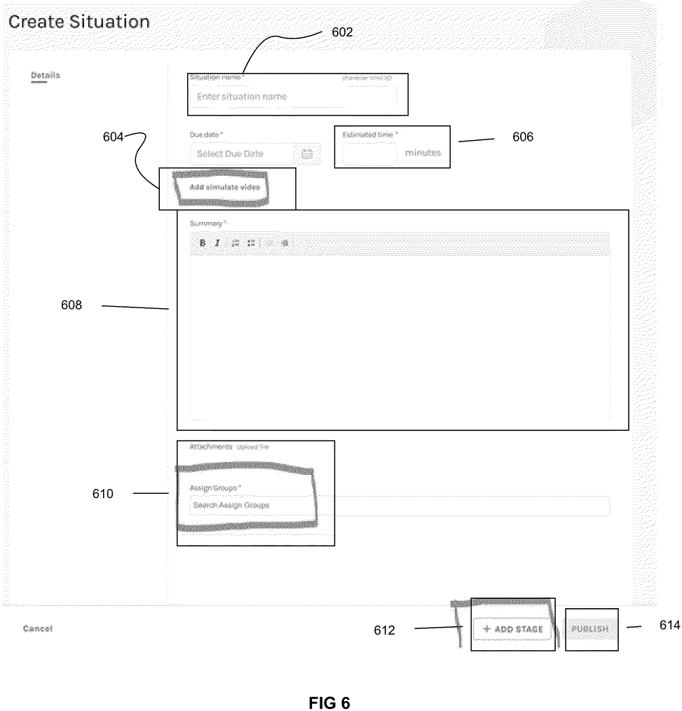

FIG. 6 shows a Create Situation Page. In order to create a Situation, the coach includes either video (with or without audio), audio, and/or Situation information (in the form of text or an attachment). The text or attachment (which could be a pdf, ppt, etc.) provides background information on the Situation. For example, within this Situation, the user will be a salesperson selling insurance services. The user is informed that he/she is working for company x and will be selling to a new potential client company y. The products the user offers are a, b, c and their pricing is 1, 2, 3, respectively.

This can also be covered with a video/audio file or with an audio only file. Generally, the best practice is to do the video/audio file for a richer user experience, and have scenario information via text or attachment and then supplement it with a video.

To set up a new Situation, the administrator of third-party evaluator uploads at least one stage. A Situation requires the scenario information (background information), at least one stage, which is the prompt for the user to provide an input. For example, in the Situation above, a stage would be “Opening a meeting” and would have either video/audio or audio prompt that is pre-recorded saying “Thanks for meeting with me today. What did you want to talk about?” This video/audio prompt then requires an input from the user setting an agenda or in some other way opening the meeting.

In addition to the scenario information and creating at least one stage, the creator also assigns groups (who will have access to this new Situation) and must record at least one prompt video and one transition video (a simulated listening video which includes a real-feel experience) which will serve as the videos that the user provides inputs to and sees while the user is providing the inputs, respectively.

In the above page one can see the place for the name of the new Simulation to be entered 602, the Due Date 604, the expected number of minutes the Simulation will take 606, the Summary which is where text information is entered 608, and below it, attachments are uploaded 610, which groups are assigned to the Simulation, and then Add Stage buttons 612 to add as many stages as one would like. Once one Stage is added, the user may click Publish 614 to finalize.

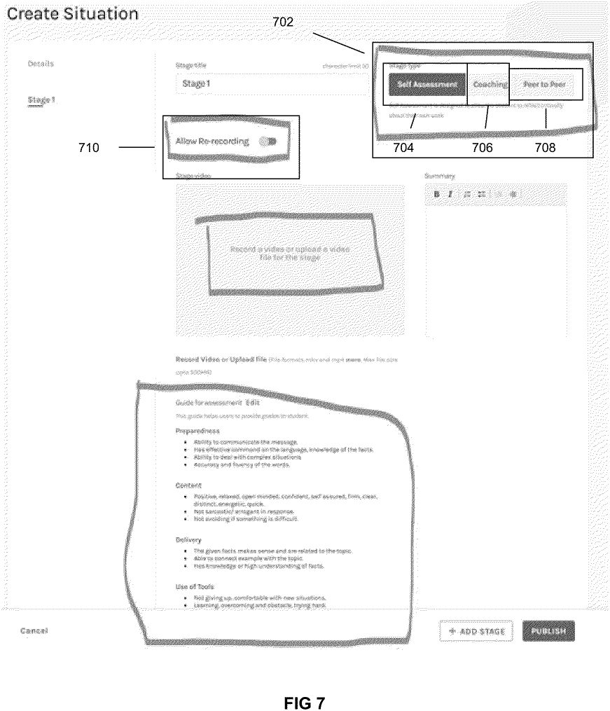

FIG. 7 shows Creating Stages, Stage Edit page.

Some Key Features include:
Assign grading type. This feature allows the administrator to decide if they want this specific stage of the situation to be graded as Self-Assessment, by a peer, or by a third-party evaluator within the group cohort. This diverse grading feature is significant as it allows for large scale grading that is not dependent on a small number of evaluators, which is the current case today.
Allow re-recording. In certain situations, a company may want to allow the user to re-record their situations. This allows for more exploratory responses as users can perfect their response over multiple iterations until they hit submit.
Assessment guide. This is an editable assessment guide the creator can create to highlight certain factors in grading. This is especially useful for the self and peer grading to help guide the user in reflecting on the stage.

This page is for creating and editing stages. At the top right box 702, the administrator decides who will grade this stage. Self-Assessment 704 entails the user, after completion, being prompted to grade themselves using a guide for assessment. Here users are provided guidance on how to grade, what to look for, etc. The same guide for assessment is also provided for third-party evaluators such as coaches 706, should that option be chosen. Third-party evaluators can be internal to an organization (e.g., managers within the insurance company who in the example is having all of their salespeople go through this) or external to the organization (e.g., an outside sales or negotiation training company). Finally, peer-to-peer 708 matches up peers to grade each other. In all cases, the guide to assessment is provided to help streamline grading.

It is also important to note that when making a Stage, the administrator can decide how many times a user is able to re-record their answer. By selecting that they can re-record 710 that then allows the creator to decide how many times. Not allowing users to re-record makes it more realistic but is a riskier setting in case users are confused, their first recording is not strong, they are not properly prepared, etc. Allowing for re-recording allows for some of the learning to take place before the user’s input is even graded. For example, if the user re-records three times that means he/she has essentially graded themselves informally several times and decided that they did not perform at a high enough level - all of this prior to being formally graded.

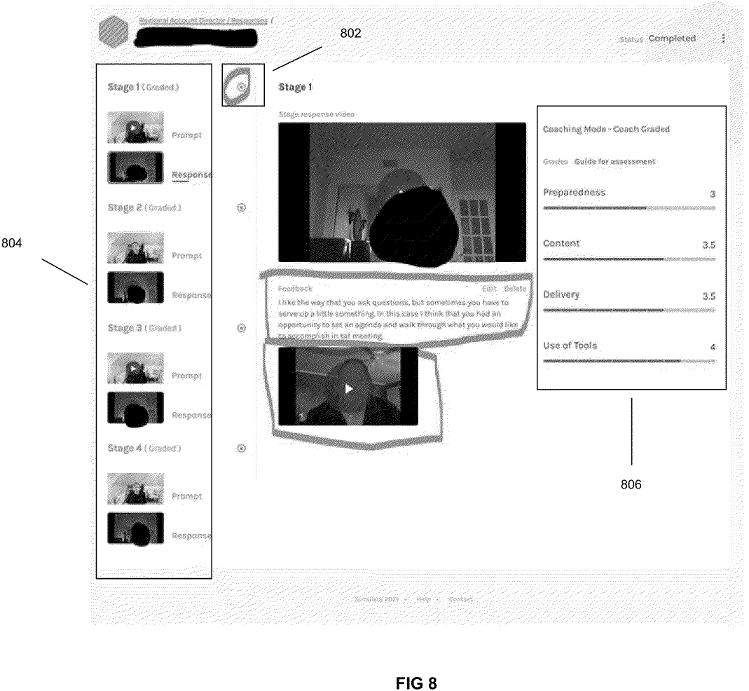

FIG. 8 shows a page for coach grading and giving feedback

This screen shows where grading occurs. Please note on the top left there is a little star 802 with a circle around it. By clicking this, the person grading the response is saying it is very well done and in turn shares it publicly within the rest of the Assigned Group. The user’s input along with the grading (score and comments) are shared so other users can view and comment on as well.

On the left side there is a column of the various stages 804, the third-party evaluator, in this case a coach, who is providing grading in this case can see all the stages. As a coach, they are assigned to grade specific user inputs, but they may over-ride and grade any inputs. After grading, they remain visible. For more context, when grading, the person grading sees the prompt video along with the input video.

The person grading has the ability to record a feedback video/audio, a response with text, and/or include an attachment. This allows for quick feedback via video/audio but also more in-depth, for example feedback, attaching a pdf with learning that relates to the input the user submitted.

Finally, on the right side 806 is the grading structure, whereby the person grading moves the circle to the left and right to decide where they grade the specific stage response. This grading structure can be changed, and there are advantages to that flexibility, but the administrator of the simulation can also keep it consistent, which allows for consistent over-time data which can then be analyzed. For example, if the same insurance simulation is done once before a training session to see how people do and to assess everyone’s ability, and then the same simulation is completed after a training session, by keeping the grading criteria, the same graders can see the improvement in each stage, which also allows managers/coaches to see what areas need further development.

### Student Walk-Through

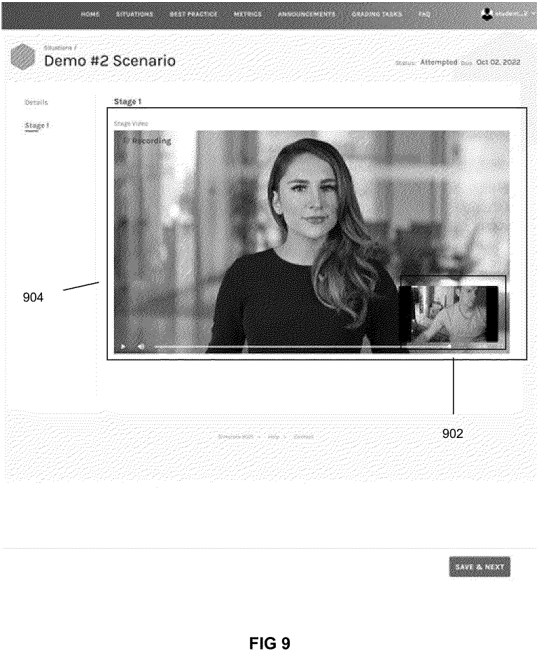

FIG. 9 shows a simulation experience page. This is a visual example of the real-feel effect. It is relevant to note that the user sees themselves in small 902 on the bottom right corner, while the person whom they are roleplaying with is on the screen in big 904, as per the norm when conducting video conferencing calls. Seeing someone else on screen is disarming and more natural. It also provides a point of reference to look at when responding. Finally, it can allow for more advanced skill building by having the person(s) within the recording react in different ways while the user is recording their input to the prompt video. For example, if in the insurance example with the Opening a Meeting stage, the transition video has the person in the video looking at their watch, this may apply a time pressure to the user recording, or not, and this adds another layer of coaching to the inputs.

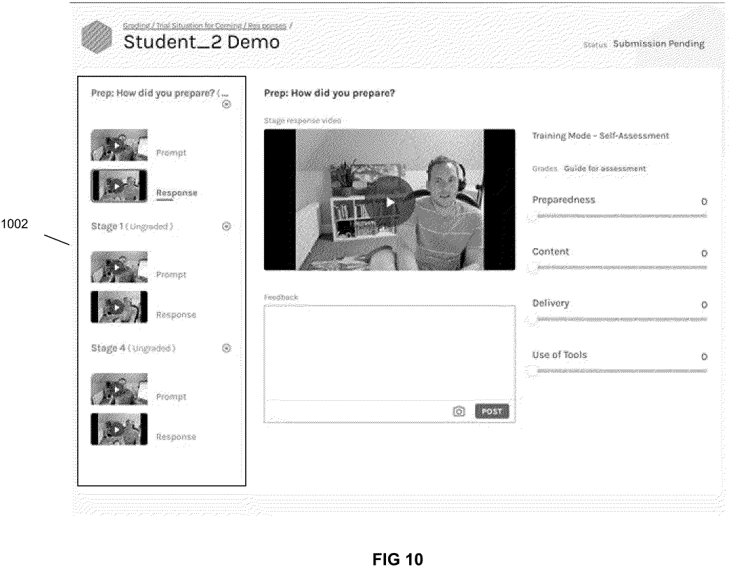

FIG. 10 shows a Student Grading page. The student grading section is very similar to the coach grading section. The only difference is in the left column 1002, coaches can see all of the inputs, whether or not they are assigned to grade them, while the user (self or peer) can only see the ones they have been assigned to grade. All other capabilities, such as best practices, feedback video/audio, text or attachment grading, the access to the guide for assessment, and the grading structure are the same.

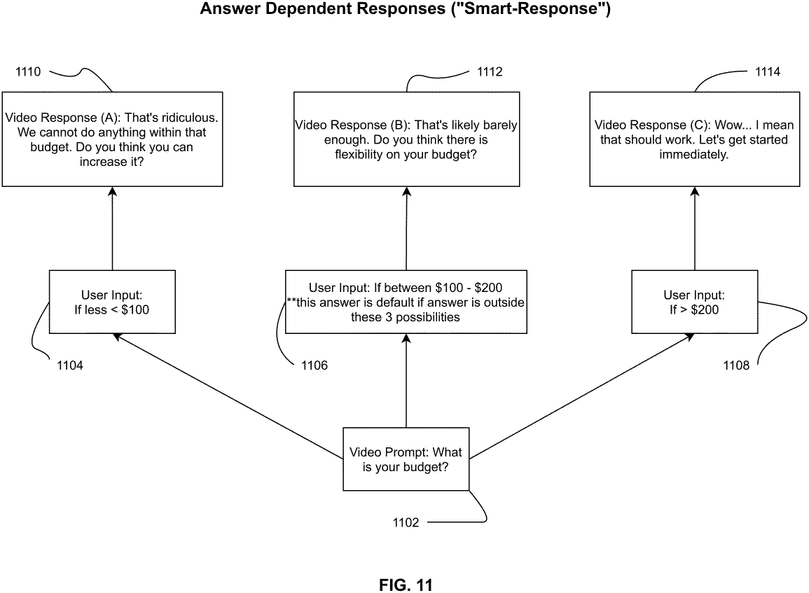

To summarize:
A prompt video is a pre-recorded video/audio that the user sees and prompts the user to provide an input.
Transition: There are two possible ways to accomplish this feature. The first is the Prompt video/audio is extended to show or sound as if the person in the video/audio is listening to the user (e.g., the video has the person nodding their head, saying “uh huh” quietly, etc., or the audio only having the person saying “hmmm” quietly). The other method is for the creator of the simulation to record video/audio specifically to appear as if listening. If this method is selected, the pre-recorded prompt plays first and then seamlessly the pre-recorded transition video plays right after it. This is what creates the real-feel effect, whereby when a user is creating an input video/audio he/she sees the person who they are roleplaying with (in the asynchronous pre-recorded videos) appear to be listening to them, and the user only sees themselves in small. This has many psychological advantages. It feels more like a real video call, it takes away much of the discomfort and unnatural nature of the user seeing themselves during the recording, etc.
Input video: This is the video/audio that the user provides in response to the prompt.
Grading: This is where the assigned grader provides the user with feedback via text, audio, or video. Here the person conducting the grading is reviewing the input video from the user and providing specific and actionable feedback. This could include, for example, what they thought was done well, what could improve, other ideas for responses, and why they graded the way they did.
Real-Feel: Having a transition video/audio be visible to a user while he/she responds in order to make the recording of a prompt video more realistic.
Best Practice: A forum like sharing of the best inputs, as decided by graders. This feature becomes visible to everyone within an Assigned Group and once posted to Best Practices, all other users can comment and promote (vote up or down).
Grading Structure: When the admin/coach creates a stage, he/she assigns who will grade it. This can be one of three categories - self, meaning the same user that completed the input video will be assigned to grade the input video; peer-to-peer, meaning a peer of the user (in the insurance example used throughout, a fellow salesperson) will grade the input video, which refers to a manager, coach, external member of the organization, etc. Coach refers to a user class that is not assigned to complete input videos but is assigned to provide coaching. The coach can be all of those things (manager, learning and development executive, external coach, etc.). Finally, the user does not know, when providing an input, who will be grading his/her input. This ensures that the user takes every response seriously.
Smart-Response: Smart response takes the audio of the user, transcribes it, and then compares the entire text to various predetermined criteria. In the example shown in FIG. 11, the stage has a prompt with a person saying, “What is your budget?” 1102. The user may provide an input 1104, 1106 or 1108. The entire input is transcribed and then a comparison will be made, within the text, to a pre-determined (by the creator of a simulation) set of parameters. For example, if the input includes a number below $100 (1104) then response video A (1101) will play, if the number is between $100-200 (1106) then video B (1112) will play, and if the number is above $200 (1108) then video C (1114) will play. The number of variations is potentially unlimited, only limited by the amount of time the creator has to work through them and create the various responses. It is important however, to select a “default” route if there is uncertainty in the comparison between the user’s answer and the pre-determined parameters. For example, if the user does not provide a number, provides a very large range, etc., then one of the responses will play, in the provided example, it would be B.
Video/Audio: According to aspects of the invention, the real feel and the coaching system can work with video, which includes audio, and audio only. When audio only is selected, a still image is loaded where the video portion goes. This allows for realistic roleplaying for users of all types, including user video conferencing or meetings in person, and for those that are used to mainly using audio, such as on the phone.

Further, the coaching system and method can be implemented without using the real-feel effect. An advantage of the coaching system and method is that the user does not who is doing the grading, while a coach can set up the grading system for any combination of the coach, the user or peer-to-peer with other users in the group.

Various embodiments of the present invention may also be implemented at different environments wherein the user is required to respond to a video. As an illustration only, without limiting the scope of the invention, the same system and method can be used for conducting online interviews, online exams, online workout sessions, online gaming, teaching and training in schools and colleges among other applications.

It shall be further appreciated by the person skilled in the art that the terms “first”, “second” and the like herein do not denote any specific role or order or importance, but rather are used to distinguish one party from another.

Any examples or illustrations given herein are not to be regarded in any way as restrictions on, limits to, or express definitions of, any term or terms with which they are utilized. Instead, these examples or illustrations are to be regarded as illustrative only. Those of ordinary skill in the art will appreciate that any term or terms with which these examples or illustrations are utilized will encompass other embodiments which may or may not be given therewith or elsewhere in the specification and all such embodiments are intended to be included within the scope of that term or terms. Moreover, the words “example” or “exemplary” are used herein to mean serving as an example, instance, or illustration. Any aspect or design described herein as “exemplary” is not necessarily to be construed as preferred or advantageous over other aspects or designs. Rather, use of the words “example” or “exemplary” is intended to present concepts in a concrete fashion.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for materials, components or elements not explicitly described also to be present. Reference to the singular is also to be construed to relate to the plural.

Although an exemplary embodiment of at least one of a system and a method has been illustrated in the accompanied drawings and described in the foregoing detailed description, it will be understood that the application is not limited to the embodiments disclosed, but is capable of numerous rearrangements, modifications, and substitutions as set forth and defined by the following claims. For example, the capabilities of the system of the various figures can be performed by one or more of the modules or components described herein or in a distributed architecture and may include a transmitter, receiver or pair of both. For example, all or part of the functionality performed by the individual modules, may be performed by one or more of these modules. Further, the functionality described herein may be performed at various times and in relation to various events, internal or external to the modules or components. Also, the information sent between various modules can be sent between the modules via at least one of: a data network, the Internet, a voice network, an Internet Protocol network, a wireless device, a wired device and/or via plurality of protocols. Also, the data sent or received by any of the modules may be sent or received directly and/or via one or more of the other modules.

One skilled in the art will appreciate that a “system” could be embodied as a processor, a computer device integrated in a vehicle, a personal computer, a server, a console, a personal digital assistant (PDA), a tablet computing device, a smartphone, a virtual reality headset, or any other suitable computing device, or combination of devices. Presenting the above-described functions as being performed by a “system” is not intended to limit the scope of the present application in any way, but is intended to provide one example of many embodiments. Indeed, methods, systems and apparatuses disclosed herein may be implemented in localized and distributed forms consistent with computing technology.

The description, embodiments and figures are not to be taken as limiting the scope of the claims. It should also be understood that throughout this disclosure, unless logically required to be otherwise, where a process or method is shown or described, the steps of the method may be performed in any order, repetitively, iteratively or simultaneously. At least portions of the functionalities or processes described herein can be implemented in suitable computer-executable instructions. It will be appreciated that features of the present disclosure are susceptible to being combined in various combinations and additional features may be introduced without departing from the scope of the present disclosure.

What is claimed is:

1. A system for asynchronous video/audio roleplay, comprising:
a memory to store a program with logical instructions; and
a hprocessor configured to execute the program to:
display a prompt video/audio on a display device;
display a transition video/audio on the display device upon the completion of the prompt video/audio;
record an input video/audio from an input device from a user while displaying the transition video/audio;
analyze the input video/audio to identify
an input from the user; and
a rule corresponding to the input from a rule set;
display a response video/audio on the display device based on the identified rule corresponding to the input upon completion of the one or more transition videos/audio;
wherein the memory stores the prompt video/audio, the rule set, the transition video/audio, the input video/audio and the response video/audio.

2. The system of claim 1, wherein the processor is further configured to facilitate reviewing of the user based on the prompt video/audio, the user input video/audio and the reviewing rule from the rule set, wherein the reviewing of the is to be done by the user, a peer, or a third-party evaluator separate from the user.

3. The system of claim 1, wherein the transition video/audio comprises a video/audio of a person expressing listening and/or reacting.

4. The system of claim 1, wherein transition video/audio is displayed on the display device until the user indicates the completion of the input video/audio.

5. The system of claim 1, wherein the input device is a video recording device or an audio recording device.

6. The system of claim 1, wherein the analysis of the video/audio by the processor includes analyzing audio of the input video using artificial intelligence or machine learning.

7. The system of claim 1, wherein the user is simultaneously displayed live on the display device along with the recorded prompt video/audio and transition video, and the response video/audio is displayed after completion of the input video/audio of the user.

8. The system of claim 1, wherein the prompt video/audio and the transition video/audio are displayed in large, while video/audio of the user is displayed in small on a same display.

9. A method of asynchronous video/audio roleplay, the method to be processed using a processor, the method comprising:
displaying a prompt video/audio on a display device;
displaying a transition video/audio on the display device upon the completion of the prompt video/audio;
receiving an input video/audio from the input device from a user while displaying the transition video/audio;
analyzing the input video/audio to identify
an input from the user; and
a rule corresponding to the input from a rule set stored in a memory;
displaying a response video/audio stored in the memory on the display device based on the identified rule corresponding to the input upon completion of the transition video/audio.

10. The method of claim 9, further comprising: reviewing the user based on the prompt video/audio, the one or more user response videos/audio and one or more reviewing rules from the one or more rule sets, wherein the reviewing of the one or more users is done by the one or more the users, peers, or a third-party evaluator separate from the said one or more users.

11. The method of claim 9, wherein the transition video/audio comprises a video of a person expressing listening and/or reacting.

12. The method of claim 9, wherein the transition video/audio is displayed on the display device until the user indicates the completion of the input video/audio.

13. The method of claim 9, wherein the input device is a video recording device or an audio recording device.

14. The method of claim 9, wherein the analysis of the input video/audio includes analyzing video and audio of the one or more response videos/audios using artificial intelligence or machine learning.

15. The method of claim 11, further comprising simultaneously displaying the user live on the display device along with the recorded prompt video/audio, and the transition video/audio, and the response video/audio is displayed after completion of the input video/audio of the user.

16. The method of claim 1, wherein the prompt video and the transition video are displayed in large, while video of the user is displayed in small on a same display.

17. A system for asynchronous video/audio roleplay, comprising:
a memory to store a program with logical instructions, a prompt video/audio, a plurality of response videos/audios, and a rule set; and
a processor configured to execute the program to:
display the prompt video/audio on a display device;
record an input video/audio from an input device from a user after displaying the prompt video/audio;
analyze the input video/audio to identify
an input from the user; and
a rule corresponding to the input from stored rule set; and
display one of the response videos/audios on the display device based on the identified rule corresponding to the input.

18. The system of claim 17, wherein one of the plurality of response videos/audios corresponds to a situation where the analysis has determined that the input is not recognizable or not acceptable.

19. A system for asynchronous video/audio roleplay, comprising:
a memory to store a program with logical instructions, prompt videos/audios, and response videos/audios; and
a processor configured to execute the program to:
display one of the prompt videos/audios on a display device for each of a plurality of users;
record input videos/audios from input devices from the users to the memory after displaying corresponding prompt videos/audios to the users; and
provide an administrator with an option to enable each user to provide a review of the input video/audio of that same user, another user to provide a review of the input video/audio of the user, or a third-party to provide a review of the input video/audio of the user.

20. The system of claim 19, wherein there is no indication to the user of which review option is to be performed at the time of the recording of the input videos/audios from the users.

21. The system of claim 19, wherein the processor is configured to provide the user or the at least one other user with a review guideline in response to being requested to perform the review of the input video/audio.

22. The system of claim 19, wherein when the users are assigned to provide a review of other users, the users are enabled to provide the review after recording their own input video/audio in response to the corresponding prompt video/audio.

23. The system of claim 19, wherein if one of the users does not perform the assigned review of another user in a predetermined time range, the processor is configured to assign the review to another reviewer or the administrator.

24. The system of claim 19, further comprising:
the memory storing transition videos/audios, the transition videos/audios being automatically displayed to each user after the corresponding prompt video/audio is displayed to the corresponding user and while each user is recording the corresponding input video/audio.

25. The system of claim 24, wherein each transition video/audio comprises a video of a person expressing listening and/or reacting.

26. The system of claim 19, wherein the processor is configured to enable each user to re-record the input video/audio.

27. The system of claim 26, wherein the processor is configured to record a number of times each user re-records the input video.

28. The system of claim 1, wherein the transition video/audio is displayed on the display device until a period of time after the user has stopped recording the input video/audio.

29. The system of claim 19, wherein the processor is configured to execute the program to: enable each reviewer to share the corresponding input video/audio with other users or the third party.
